(19) United States
(12) Patent Application Publication
(10) Pub. No.: US 2026/0093482 A1
(43) Pub. Date: Apr. 2, 2026

(54) DETECT REDUNDANT INITIALIZATION CHECKS USING STATIC ANALYSIS

(71) Applicant: Oracle International Corporation, Redwood Shores, CA (US)

(72) Inventors: Christian WIMMER, Belmont, CA (US); Liviu Codrut STANCU, Zurich (CH); David KOZAK, Svitavy (CZ)

(73) Assignee: Oracle International Corporation, Redwood Shores, CA (US)

(21) Appl. No.: 18/902,337

(22) Filed: Sep. 30, 2024

(51) Int. Cl. G06F 8/72; G06F 8/41

(52) U.S. Cl. CPC G06F 8/72; G06F 8/4443

(57) ABSTRACT

A method detects redundant initialization checks using static analysis. The method includes inlining source code to generate inlined code. The inlined code includes instructions to materialize an element within a scope. The method further includes consolidating the inlined code to form consolidated code by moving the instructions to materialize the element to a point where the element escapes the scope. The method further includes running a points-to analysis on the consolidated code. The method further includes reducing the consolidated code to generate reduced code by removing an initialization check from the consolidated code.

### BACKGROUND

A null check is a programming construct that verifies whether a variable or object has a valid reference or value before attempting to access or manipulate the variable or object. Initialization checks (including null checks) may be performed to prevent runtime errors, crashes, or unpredictable behavior that can occur when trying to access or use an uninitialized element, e.g., a null or undefined variable or object. As an example, the Java programming requires explicit null checks before instance method calls and instance field accesses. A NullPointerException is thrown when a value is null. Including initialization checks may require machine code, which increases the size of a binary executable and slows down execution of the code. A challenge is to determine when initialization checks in code may be safely removed.

### SUMMARY

In general, in one or more aspects, the disclosure relates to a method detects redundant initialization checks using static analysis. The method includes inlining source code to generate inlined code. The inlined code includes instructions to materialize an element within a scope. The method further includes consolidating the inlined code to form consolidated code by moving the instructions to materialize the element to a point where the element escapes the scope. The method further includes running a points-to analysis on the consolidated code. The method further includes reducing the consolidated code to generate reduced code by removing an initialization check from the consolidated code.

In general, in one or more aspects, the disclosure relates to a system that includes at least one processor and an application that executes on the at least one processor. Executing the application performs inlining source code to generate inlined code. The inlined code includes instructions to materialize an element within a scope. Executing the application further performs consolidating the inlined code to form consolidated code by moving the instructions to materialize the element to a point where the element escapes the scope. Executing the application further performs running a points-to analysis on the consolidated code. Executing the application further performs reducing the consolidated code to generate reduced code by removing an initialization check from the consolidated code.

In general, in one or more aspects, the disclosure relates to a non-transitory computer readable medium including instructions executable by at least one processor. Executing the instructions performs inlining source code to generate inlined code. The inlined code includes instructions to materialize an element within a scope. Executing the instructions further performs consolidating the inlined code to form consolidated code by moving the instructions to materialize the element to a point where the element escapes the scope. Executing the instructions further performs running a points-to analysis on the consolidated code. Executing the instructions further performs reducing the consolidated code to generate reduced code by removing an initialization check from the consolidated code.

Other aspects of one or more embodiments may be apparent from the following description and the appended claims.

### BRIEF DESCRIPTION OF DRAWINGS

FIG. 1 shows a diagram in accordance with the disclosure.

FIG. 2 shows a method in accordance with the disclosure.

FIG. 3, FIG. 4, FIG. 5, FIG. 6, FIG. 7, FIG. 8, FIG. 9, FIG. 10, and FIG. 11 show examples in accordance with the disclosure.

FIG. 12A and FIG. 12B show computing systems in accordance with the disclosure.

Similar elements in the various figures are denoted by similar names and reference numerals. The features and elements described in one figure may extend to similarly named features and elements in different figures.

### DETAILED DESCRIPTION

Embodiments of the disclosure detect and remove initialization checks upon detecting elements that are not accessed after allocation and prior to initialization. As an example, null checks may be removed by detecting never-null instance fields using static analysis. An element may be an object, a variable, a field, a primitive, etc., that is materialized. An element is materialized by being allocated and then being initialized. Allocation may include the process of reserving memory for an element (a variable, data structure, an object, etc.). Initialization is the process of setting an initial value for an element in the memory that was allocated for the element to be used during execution. An allocated value may be provided for an element at the time of allocation to indicate that the element has been allocated but not yet initialized. For example, the value of “null” may be an allocated value for methods and objects prior to initialization and the value of “0” may be an allocated value for variables and primitives prior to initialization. An initialized value may be provided at the time of initialization for an element, which occurs after the time of allocation. The initialized value may be a value useful to the process using the element and may be different than the allocation value. The allocated value for methods and objects may be an identifier that references the method or object and the allocated value for variables or primitives may be non-zero values.

To remove an initialization check, systems and methods of the disclosure may reorder and reorganize the source code of a program to determine whether an element (an object, a variable, a field, etc.) is accessed after being allocated and before being initialized. Systems and methods of the disclosure may outline and inline the materialization of elements within source code. After inlining, a partial escape analysis may be performed and the operations of the source code reordered to move the materialization of an element to a point of escape from a scope.

A point of escape from a scope refers to a location in the source code where control may exit a scope. A scope is the region of a program where an element (an object, a variable, a primitive, etc.) is defined and is accessible. Points of escape may include points where a function returns, a loop iterates to the end of the loop, a conditional statement evaluates to false, a method is called, etc. At the point of escape, local elements declared within the scope may no longer be accessible. Points of escape can be explicit, such as a function return statement, or implicit, such as reaching the end of a loop or block.

After moving the materialization of the element to the point of escape, a points-to analysis (which may be a static analysis) may be performed. Due to the inlining and the movement of the materialization of the element, a determination may be made as to whether the element is accessed after allocation and prior to initialization. If the element is not accessed after the allocation and prior to the initialization, then an initialization check after the allocation and prior to the initialization of the element may be removed.

As noted above, embodiments of the disclosure may remove initialization checks upon detecting elements that are not accessed after allocation and prior to initialization. The detection as well as the removal of initialization checks improves software technology, compiler technology, and optimization technology. Optimization technology is improved by providing optimizers that produce code that is more optimized by reducing the number of instructions to perform the same task. Compiler technology is improved by providing compilers that output executable files with smaller footprints and faster runtimes. Software technology is improved by providing software with fewer redundant instructions, decreased footprints, reduced run times, and requiring fewer resources as compared to systems that do not implement the detection and removal of initialization checks as described in the disclosure.

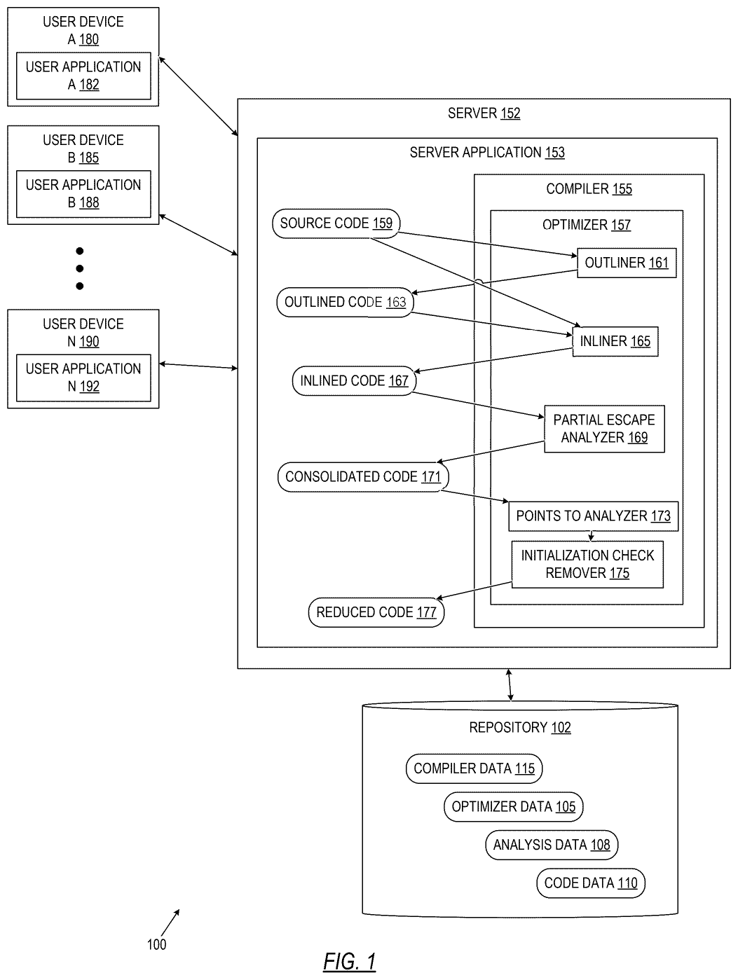

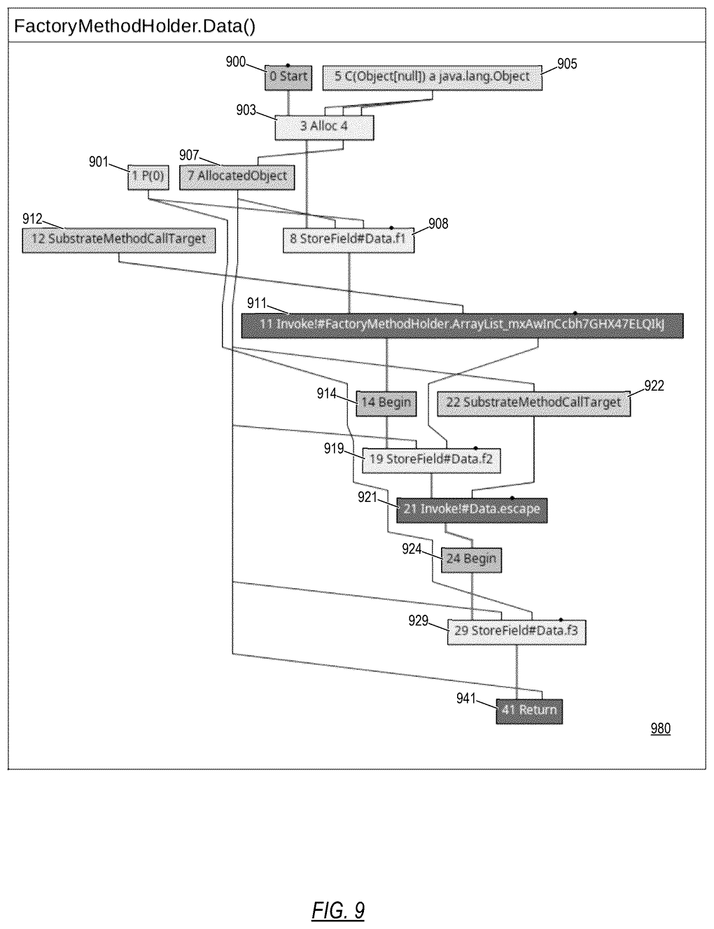

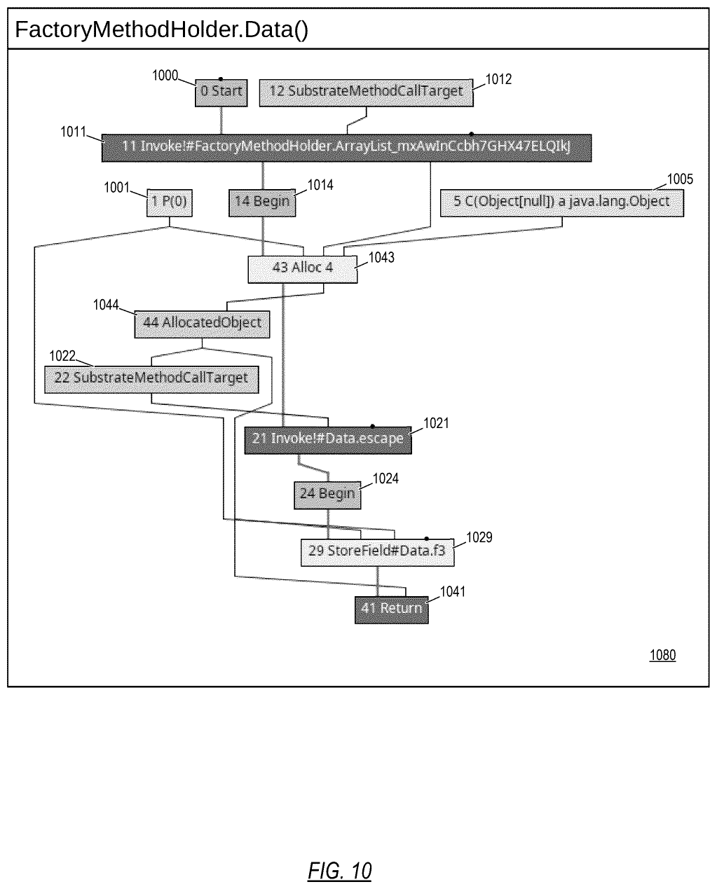

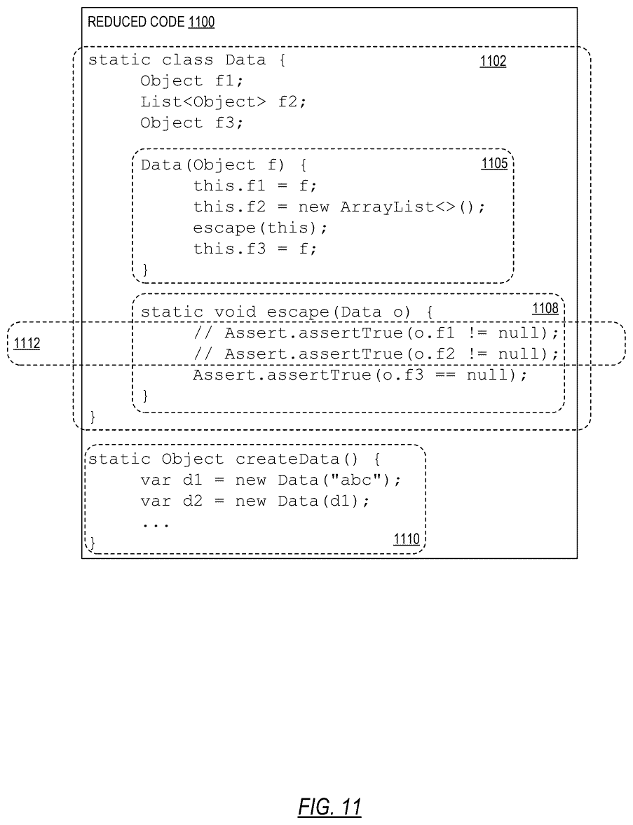

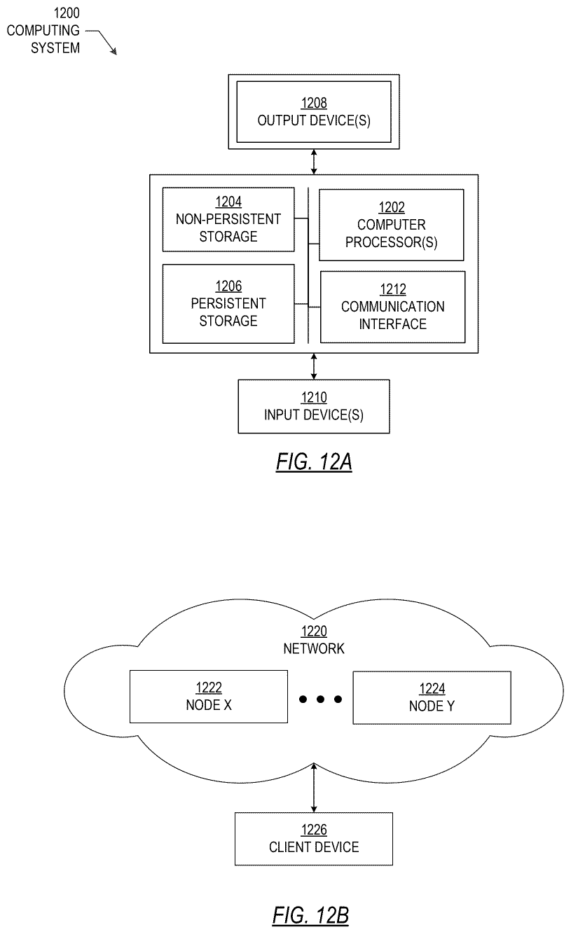

Turning to FIG. 1, the system (100) is a computing system that operates to detect and remove initialization checks upon detecting elements that are not accessed after allocation and prior to initialization. The components of the system (100) may each include one or more processors and one or more memories with data and instructions in accordance with the computing systems described in FIG. 12A and FIG. 12B. The processors load data and instructions from the memories into registers of the processors, process the data in the registers in accordance with the instructions, and store results in the registers back to the memories. The system (100) includes the server (152) that communicates with the repository (102) and the user devices A (180) and B (185) through N (190).

The repository (102) is a collection of storage devices (e.g., file systems, databases, data structures, etc.) that store and maintain the data used by the system (100). The repository (102) may include multiple different, potentially heterogenous, storage devices. The repository (102) stores data utilized by other components of the system (100). The data stored by the repository (102) includes the compiler data (115), the optimizer data (105), analysis data (108), and the code data (110).

The compiler data (115) is data related to the compiler (155) that may be stored in the memory of the server (152). The compiler data (115) may include the executable files of the compiler (155) and include information collected and used by the compiler (155) to optimize the compilation process and generate machine code. The compiler data (115) may include information about the source code (159), such as symbol tables, control flow graphs, data flow analysis, type information, and optimization information. The compiler data (115) may also include debugging information to help debug the compiled code. The compiler data (115) may include information about the structure and behavior of source code (e.g., the code data (110)) for the compiler (155) to make informed decisions about code generation, optimization, and error detection. By analyzing and utilizing the compiler data (115), the compiler (155) may produce high-quality machine code that is efficient, reliable, and optimized for a target machine.

The optimizer data (105) is data related to the optimizer (157) that may be stored in the memory of the server (152). The optimizer data (105) may include information used by the optimizer (157) to make determinations about optimizing machine code generated from the source code (159). The optimizer data (105) includes information about the source code (159), such as execution frequencies, branch probabilities, and data dependencies, as well as information about the target machine, such as its architecture, instruction set, and performance characteristics. The optimizer data (105) may also include information about the types of optimization to perform, such as reducing execution time, minimizing code size, or improving power efficiency. By analyzing and utilizing optimization type data, the optimizer (157) may perform optimization techniques, such as code outlining, code inlining, loop unrolling, dead code elimination, register allocation, etc., to produce optimized machine code in accordance with the optimization type data.

The analysis data (108) is the data generated during the analysis of the code data (110), including the source code (159), that may be stored in the memory of the server (152). The analysis data (108) may include the intermediate and output data generated by the compiler (155) and the optimizer (157), including the outlined code (163), the inlined code (167), and the consolidated code (171).

The code data (110) is data related to the code processed by the compiler (155). The code data (110) may include information used to create a program or software application. The code data (110) may form a computer program and include a series of instructions written in a programming language. Programming languages include Python, Java, C++, ANSI C, etc. The code data (110) may take the form of text files, binary files, visual representations (e.g., diagrams and flowcharts), etc. The code data (110) is used by a processor to execute specific tasks, perform calculations, and manipulate data. The code data (110) may include the source code (159) and the reduced code (177).

Continuing with FIG. 1, the server (152) may be a collection of one or more computing systems that provides services, resources, or data to other devices over a network. The server (152) may manage and control access to shared resources, such as files, databases, or applications. The server (152) communicates with the user devices A (180) and B (185) through N (190) and the repository (102). The server (152) may be physical or virtual and may be configured to perform a wide range of tasks, including hosting websites, running applications, storing and managing data, providing services like email or file sharing, etc. When one of the user devices A (180) and B (185) through N (190) requests access to a resource or service, the server (152) processes the request and sends the requested data or information back to the requesting device. The server (152) may execute the server application (153).

The server application (153) may be a collection of programs operated as components and executed on the server (152). The server application (153) may provide a specific service or functionality to the user devices A (180) and B (185) through N (190) or other devices over a network. The server application (153) may manage and control access to shared resources, such as databases, files, or applications, and may operate in a continuous loop, waiting for incoming requests from clients including the user devices A (180) and B (185) through N (190). The server application (153) may operate as a web server (hosting and serving websites), a message server (managing and delivering messages including emails, media posts, streams, etc.), and a database server (storing and managing data for multiple applications). The server application (153) may be scalable, secure, and fault-tolerant, and be written using one or more programming languages. The server application (153) utilizes several components to process several forms of data. The data and components of the server application (153) may include the compiler (155), the optimizer (157), the source code (159), the outliner (161), the outlined code (163), the inliner (165), the inlined code (167), the partial escape analyzer (169), the consolidated code (171), the points-to analyzer (173), the initialization check remover (175), and the reduced code (177).

The compiler (155) may be a collection programs operated as a component of the server application (153) to process the source code (159). The compiler (155) translates source code (e.g., the source code (159)) written in a programming language into machine code that can be executed directly by a processor. The compiler (155) takes the source code (159) as input, analyzes the source code, and may generate an object file or executable file that may be run on a target machine. The compilation process involves several stages and intermediate steps, including lexical analysis, syntax analysis, semantic analysis, and code generation, which may be performed by the optimizer (157). The compiler (155) may check the source code (159) for errors, warnings, and syntax violations, and generate an error message if any issues are found. Once the compilation is complete, the resulting machine code can be executed by the target machine to run and perform the intended function of the source code.

The optimizer (157) may be a collection of programs operated as a component of the compiler (155). The optimizer (157) may analyze and transform the source code (159) to improve its performance, efficiency, or size and form the reduced code (177). The optimizer (157) may generate and process the source code (159), intermediate code (such as the outlined code (163), the inlined code (167), the consolidated code (171), etc.), and object code (which may be generated by the compiler (155)) and applies one or more techniques to optimize the original code (i.e., the source code (159)). The optimizer (157) may remove unnecessary instructions, reorder code for better execution and for reduced memory access. The optimizer (155) generates code that may run faster, use less memory, and be smaller in size, while preserving the functionality and correctness of the original code (i.e., the source code (159)). The optimizer (157) may operate at various stages of a compilation process, including during compilation, linking, or runtime, and may be used in conjunction with the compiler (155) to generate highly optimized machine code, e.g., the reduced code (177).

The source code (159) may be human-readable code written in a programming language, such as Java, Python, C++, ANSI C, etc., and stored to text files in the code data (110). The source code (159) may be a set of instructions that may execute to perform one or more tasks and process data. The source code (159) may include a series of statements, functions, and data structures that define the behavior of a program. The source code (159) may be part of a software project that the compiler (155) processes to generate the machine code to be executed by a processor. The source code (159) may be input to one or more of the outliner (161) and the inliner (165).

The outliner (161) is a component of the optimizer (157) that identifies and extracts frequently executed code sequences or loops from a program and reorganizes them into a more efficient structure. The outliner (161) analyzes the control flow and data dependencies of a program to identify opportunities for optimization, such as loops that can be unrolled. The outliner (161) may reorder the code to minimize branching, reduce memory access, and improve instruction-level parallelism. Reordering the code may include extracting instructions to materialize an element in the source code (159) by replacing the instructions to materialize the element in the source code (159) with a call to a synthetic method that includes the instructions to materialize the element. A synthetic method may be a method that is automatically generated by the compiler to facilitate analysis, compilation, execution, etc., of the code without being explicitly declared or written by a developer. The outliner (161) may also perform other optimizations, such as dead code elimination, constant folding, and register allocation, to further improve program performance. The outliner (161) may operate on the source code (159) to generate the outlined code (163).

The outlined code (163) may be a version of the source code (159) in which one or more sections include code that has been outlined. The outlined code (163) may include a synthetic method that includes instructions to materialize an element. Code that has been outlined may refer to a section of code that has been extracted and placed outside of a loop or frequently executed code path, which may be done to make the code more efficient and improve performance. The code that is outlined may be placed in a separate function or block that is called from the original location using a function call or jump instruction. The outlined code (163) may be input to the inliner (165).

The inliner (165) is a component of the optimizer (157) that may replace function calls with the actual code of the called function to eliminate overhead of the calling of the function and return. The inliner (165) may analyze the call graph of a program to identify functions that are frequently called or have a small body of code, and then replaces the function call with the inlined code (167). Inlining may improve performance by reducing the number of function calls, eliminating the overhead of parameter passing and return value handling, and allowing for further optimizations such as dead code elimination and register allocation. Inlining may also improve instruction-level parallelism by increasing the size of the basic block, allowing the compiler to schedule instructions more efficiently. The inliner (165) may operate on one or more of the source code (159) and the outlined code (163) to generate the inlined code (167).

The inlined code (167) may be a version of the source code (159) (or the outlined code (163)) in which one more sections of code have been inserted directly (i.e., inlined) into the calling code, replacing a function call or jump instruction. The inlining may reduce the overhead of the function call and return, and to improve performance by reducing the number of jumps and branches. Inlining may replace a function call with the actual code of the called function, allowing for further optimizations such as dead code elimination, register allocation, and instruction-level parallelism. Inlined code (167) may improve performance by reducing the overhead of function calls, improving cache locality, and enabling more aggressive optimization techniques. The inlined code (167) may be input to the partial escape analyzer (169).

The partial escape analyzer (169) is a component of the optimizer (157) that analyzes the behavior of elements (e.g., variables, objects, etc.) in a program (e.g., of the source code (159)) to determine whether the elements may be reordered (i.e., consolidated) and safely allocated on a stack or be allocated on a heap. The analyzer may examine the code to identify and reorder elements that are accessed within a limited scope, such as in a function or loop, and determines whether the elements may be safely allocated on the stack to avoid using heap allocation (and avoid corresponding garbage collection). By identifying and reordering elements that do not “escape” a local scope, the partial escape analyzer (169) may reduce memory allocation overhead, improve performance, and enable more efficient use of memory. Partial escape analysis is useful in languages that use garbage collection to reduce the amount of memory managed by the garbage collector. The partial escape analyzer (169) may operate on the inlined code (167) to generate the consolidated code (171).

The consolidated code (171) (which may not be object code) may be a modified version of the source code (159), where elements (e.g., variables) that are determined to be non-escaping may be reordered and allocated on the stack instead of the heap. The consolidated code (171) may also include annotations or metadata inserted into the code to indicate which elements are stack-allocated and which are heap-allocated. The consolidated code (171) may be more efficient and have reduced memory allocation overhead, making the consolidated code (171) better suited for execution on the target machine. The consolidated code (171) may be input to the points-to analyzer (173).

The points-to analyzer (173) is a component of the optimizer (157) that analyzes the relationships between elements (e.g., variables) and memory locations in a program. The points-to analyzer (173) may determine which elements point to which memory locations, and which memory locations are pointed to by which elements. The points-to analyzer (173) may identify aliases, which are multiple names for the same memory location, and to track the flow of data through the program. The points-to analyzer (173) may further identify the allocation, access, and initialization of elements. The points-to analyzer (173) uses this information to enable optimizations such as dead code elimination, register allocation, and instruction-level parallelism. By understanding the relationships between variables and memory locations, the points-to analyzer (173) can help the optimizer to eliminate unnecessary code, reduce memory access overhead, and improve the overall performance of the program. The points-to analyzer (173) may use techniques such as pointer analysis and alias analysis to build a graph of the points-to relationships in the program of the source code (159). The output of the points-to analyzer (173) may be inputs to the initialization check removal (175).

The initialization check remover (175) is a component of the optimizer (157) that analyzes and removes unnecessary checks for initialization of elements in a program. The initialization check remover (175) identifies elements that are initialized before being accessed and may remove checks or other code that verifies the initialization of such elements. The optimization provided by the initialization check remover (175) is based on the analysis of the control flow and data dependencies of the program, which allows the initialization check remover (175) to determine that certain elements are initialized (e.g., never null) before being accessed. By removing the unnecessary checks, the initialization check remover (175) can improve the performance of the program by reducing the number of instructions executed and eliminating unnecessary overhead. The initialization check remover (175) may process the consolidated code (171) with output from the points-to analyzer (173) to generate the reduced code (177).

The reduced code (177) may be a modified version of the source code (159) where unnecessary checks for initializations of elements have been removed. The removal of initialization checks may result in the elimination of instructions (conditional statements, function calls, etc.) that verify the initialization of elements, and may include the removal of associated error handling code. As a result, the reduced code (177) may be more efficient and streamlined, with fewer instructions and less overhead than the source code (159). The reduced code (177) may be more compact and efficient, with improved performance and reduced overhead.

Continuing with FIG. 1, the user devices A (180) and B (185) through N (190) may interact with the server (152). The user devices A (180) and B (185) through N (190) may be computing systems in accordance with FIG. 12A and FIG. 12B. The user devices A (180) and B (185) through N (190) may include and execute the user applications A (182) and B (188) through N (192).

The user applications A (182) and B (188) through N (192) are programs that operate on the user devices A (180) and B (185) through N (190) to provide user interaction by collecting user inputs and displaying outputs in response to the user inputs. The user applications A (182) and B (188) through N (192) may include user interfaces with user interface elements to receive inputs and display outputs to the users of the system (100).

The user device A (180) may be operated by a user to interact with the server (152). For example, the user may interact with a user interface to identify the source code (159) within the code data (110) of the repository (102) and compile and optimize the source code (159) to the reduced code (177).

The user device N (190) may be operated by a user to interact with the server (152). For example, the user may interact the user interface to execute the reduced code (177).

Although described within the context of a client server environment with servers and user devices, aspects of the disclosure may be practiced with a single computing system and application. For example, a monolithic application may operate on a computing system (100) to perform the same functions as one or more of the applications executed by the server (152) and the user devices A (180) and B (185) through N (190).

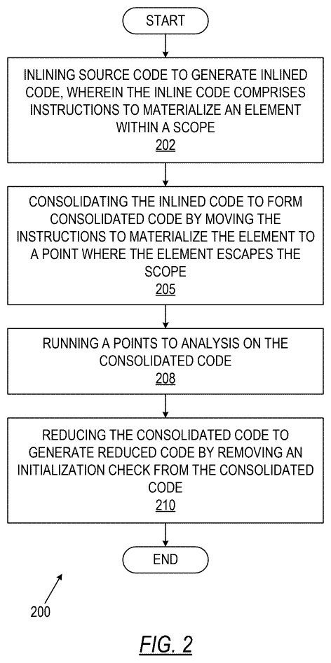

FIG. 2 shows a flowchart of a method to detect redundant initialization checks using static analysis. The method of FIG. 2 may be implemented using the system of FIG. 1, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 2, the process (200) may be part of the application that detects and removes redundant initialization checks. The process (200) may include multiple steps (e.g., steps (202) through (212)) that may execute on the components described in the other figures, including those of FIG. 1.

Step (202) includes inlining source code to generate inlined code. The inlined code includes instructions to materialize an element within a scope. Inlining the source code may include replacing a function call in the source code with the instructions from the function that is called to generate the inlined code. The inlined code may execute faster since the inlined code does not execute a function call and then a return to execute the instructions from the function.

A function call is the process of invoking or executing a pre-defined block of code, known as a function, procedure, method, etc., in a program. When a function is called, control of the program is passed to the code of the function, which performs the task specified by the instructions within the function using the inputs provided to the function. The inputs provided to the function, if any, are processed by the function, which may return a result. Once the function completes, control returns to the point in the program where the function was called.

Function calls affect memory through the use of a stack (referred to as a call stack). When a function is called, a new stack frame (i.e., portion of the call stack) is created in memory to store information like the local variables, parameters, return address, intermediate results, etc., of the function. Each new function call pushes a new stack frame onto the call stack. Once the function completes execution, the stack frame of the function is popped off of the call stack, freeing up the memory. The use of many nested or recursive function calls may lead to significant memory usage, and in extreme cases, result in stack overflow if the call stack exceeds a memory limit.

The instructions to materialize an element, when executed, materialize the element. The instructions to materialize the element include instructions to allocate the element and instructions to initialize the element so that the materialization of an element includes the allocation and initialization of the element. An element may be an object, a field, a primitive, a member, a variable, etc.

The scope refers to the context or region within a program where the element may be accessed. The scope defines the visibility and lifetime of the elements to control where the elements may be used. The scope may correspond to a class method of a class and the element comprises an object instantiated from the class for an object-oriented programming language.

Inlining may be performed during a compilation process where a compiler analyzes the source code and identifies the function calls that may be inlined. The compiler may then replace the function calls with the actual code from the functions to eliminate the overhead of the function calls and returns.

Inlining the source code may include outlining the source code to generate outlined code prior to inlining the source code. Outlining the source code may be performed by replacing the instructions to materialize the element in the source code with a call to a synthetic method that includes the instructions to materialize the element. In this way, the instructions to materialize the element, which may occur at several different places within the source code, may be condensed to a single location in the synthetic method. Condensing the instructions to materialize the element from multiple locations in the source code to a single location in the synthetic method of the outlined code reduces the number of locations to analyze by the optimizer. Instead of analyzing the multiple materialization locations (i.e., multiple locations that include instructions to materialize the element) in the source code, the optimizer may analyze the single materialization location within the synthetic method.

The outlined code is a version of the source code in which instructions to materialize an element are outlined to a synthetic method. After outlining, the process of inlining the source code may include inlining the outlined code.

Inlining the source code may include inlining the instructions to materialize the element to a synthetic method to form the inlined code.

The instructions to materialize the element includes instructions to allocate the element and instructions to initialize the element. The instructions to materialize the element may include function calls. Inlining the instructions to materialize the element, which may be within the synthetic method, may include replacing the function calls with the instructions from the body of the functions.

Continuing with the process (200), Step (205) includes consolidating the inlined code to form consolidated code by moving the instructions to materialize the element to a point where the element escapes the scope. The point where the element escapes may be with respect to and within the inlined code. Consolidating the inlined code may include executing a partial escape analyzer to perform a partial escape analysis on the inlined code to generate the consolidated code. Performing a partial escape analysis may include identifying the scope of the inlined code. Performing a partial escape analysis may further include identifying an access to the element as the point where the element escapes the scope before the end of the scope. The access to the element may be by an instruction that uses the element as an input to a function call.

Consolidating the inlined code may further include consolidating the instructions to materialize the element with instructions to materialize a supplemental element in the consolidated code by initializing and allocating the element and the supplemental element as one unit. For example, the element may be a first variable used within a program and the supplemental element may be a second variable used within the program. Consolidating the materialization of the element and the supplemental element may include the memory locations for the element and the supplemental element being adjacent and using a single allocation operation to allocate the adjacent memory locations for the element and the supplemental element.

Consolidating the inlined code may include consolidating the instructions to materialize the element to a single materialization site in a synthetic method for an application comprising the scope. Each element that is materialized in the scope may include allocation and initialization as well as zero or more accesses to the element within the scope. The scope may include additional instructions for operations in addition to the instructions for materializing the elements. The additional instructions may be intertwined with the materialization instructions. The consolidation process may reorder and move the materialization instructions to be located together (e.g., consecutively) with the additional instructions outside the grouping of the materialization instructions.

Continuing with the process (200), Step (208) includes running a points-to analysis on the consolidated code. A points-to analysis is a static analysis technique used to determine the possible memory locations (or “points”) a pointer or element may refer to during execution of a program. The points-to analysis identifies the relationships between elements and corresponding memory addresses, to track the flow of data through a program. The points-to analysis may identify the allocation, access, and initialization of elements. The information generated by the points-to analysis may be used to enable optimizations such as dead code elimination, register allocation, and instruction-level parallelism.

Step (210) includes reducing the consolidated code to generate reduced code by removing an initialization check from the consolidated code. The reduction of the consolidated code may be based on and responsive to the points-to analysis of the consolidated code.

The initialization check may be a null check for an object. A null check for an object may determine if a pointer to the object has a value of null, which indicates that the object has not been initialized.

The initialization check may be a zero value check for a primitive. A zero value check for a primitive may determine if the value of the primitive is zero. A primitive may be a basic data type of a programming language that represents a simple value rather than an object. Primitives may include types like integers, floating-point numbers, booleans, and characters. Primitives may be stored directly in memory and be handled more efficiently by the system since primitives are not complex structures like objects.

Reducing the consolidated code may further include determining that the element is not accessed within the scope after the instructions to allocate the element and prior to the instructions to initialize the element. The instructions to materialize the element may include instructions to allocate the element and instructions to initialize the element. The determination may be performed by identifying that none of the instructions in the control flow path between the allocation instructions and the initialization instructions for an element are instructions that access the element.

Reducing the consolidated code may include removing the initialization check after determining that the element is not accessed within the scope between instructions to allocate the element and instructions to initialize the element. The removal may be performed in different ways for different levels of code. At the machine code level, the instructions that make up the initialization check may be removed. At the programming language level, the instructions that make up the initialization check may be commented out by including one or more commenting symbols around the instructions that make up the initialization check to prevent the compilation and execution of the initialization check.

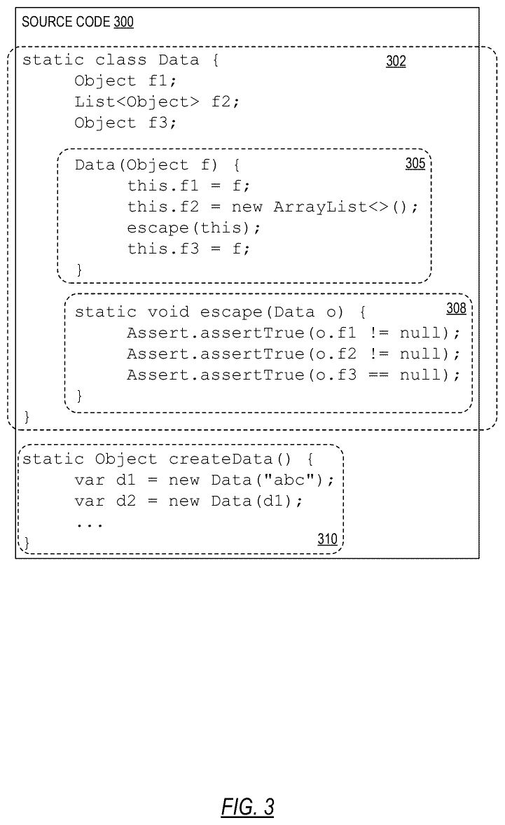

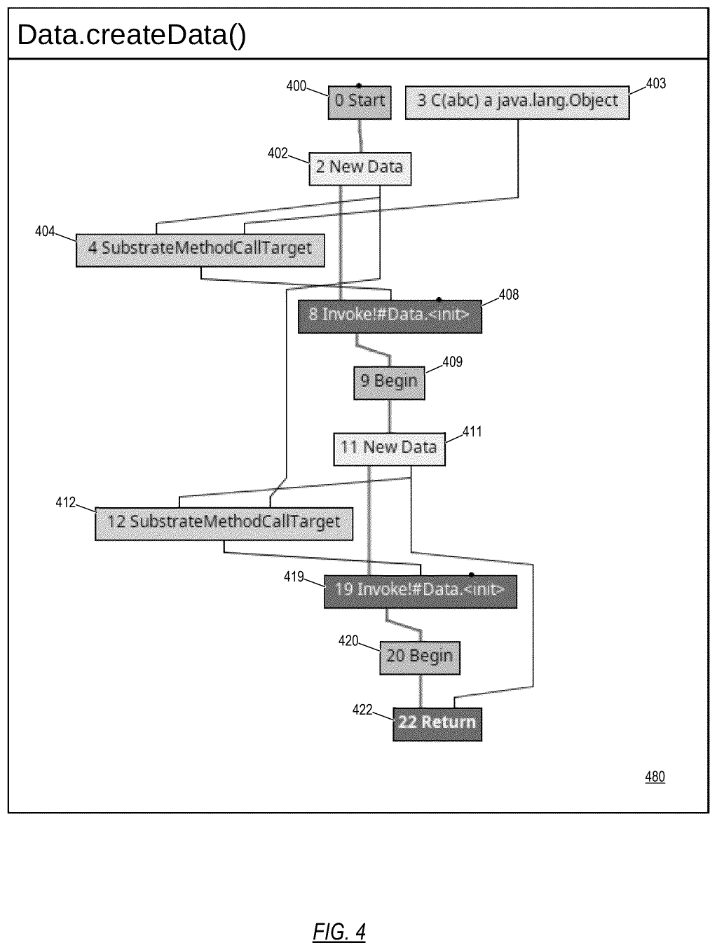

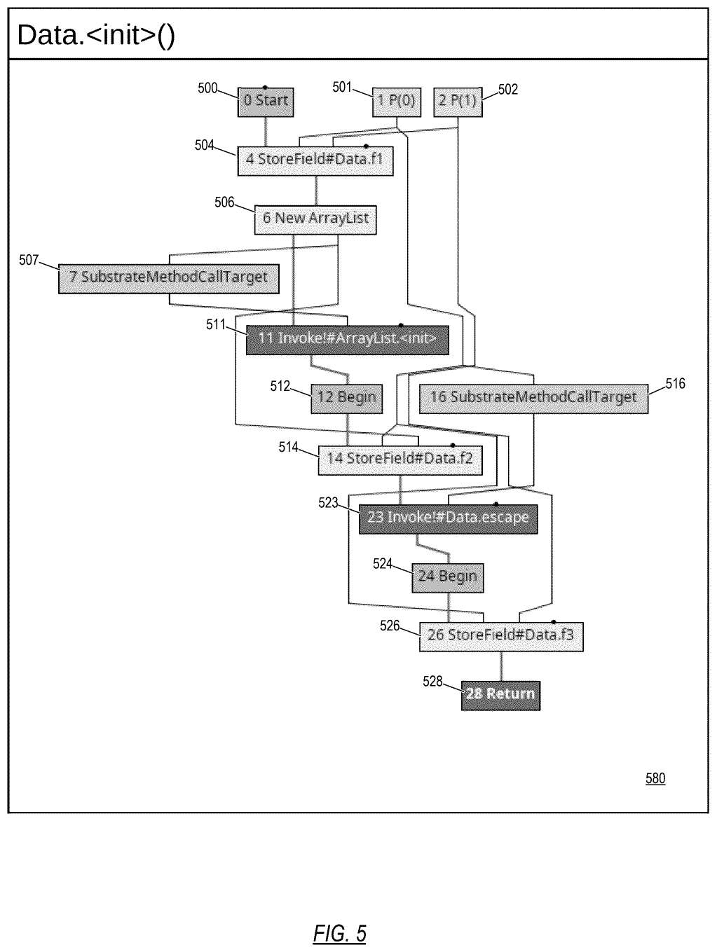

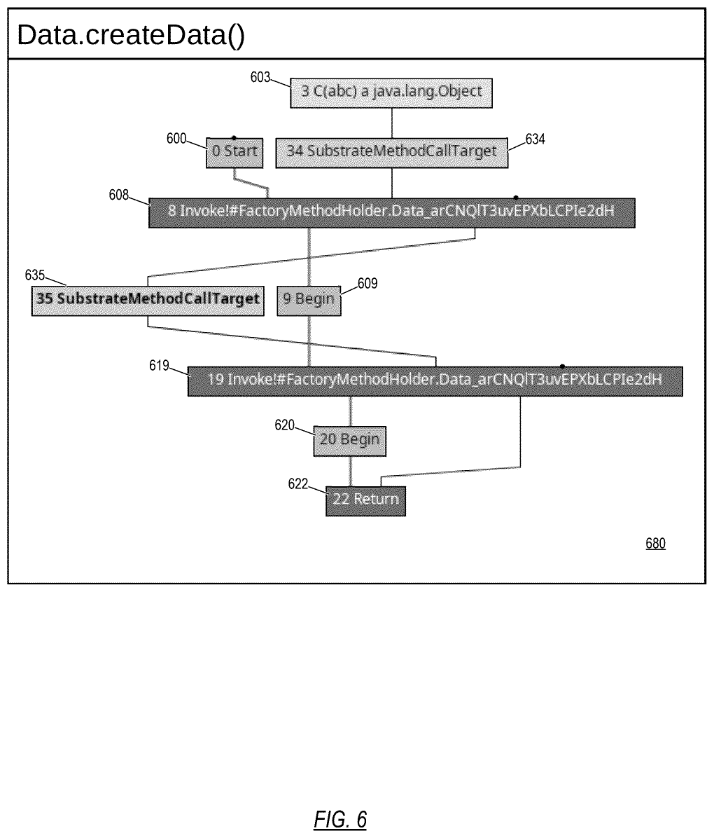

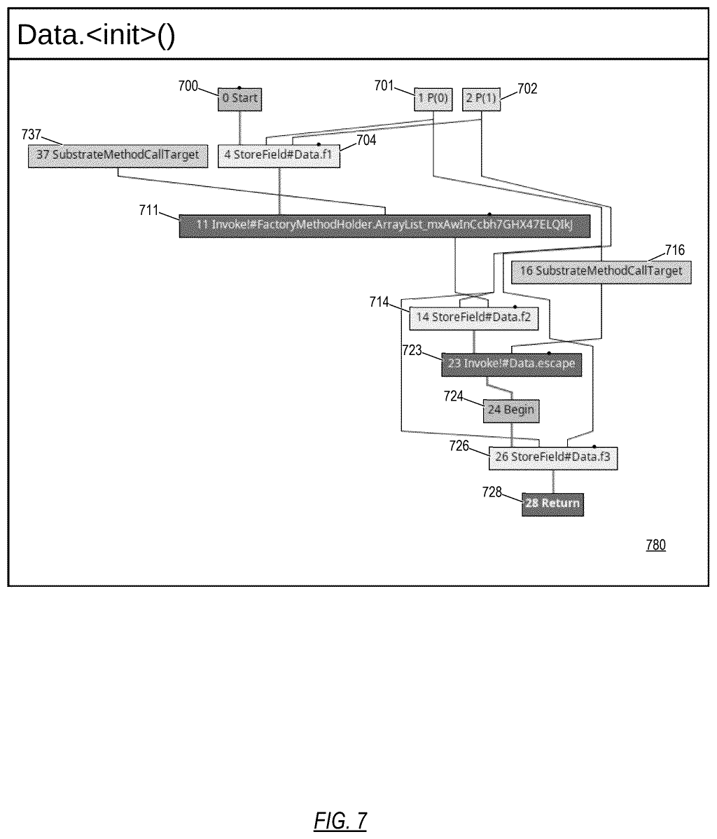

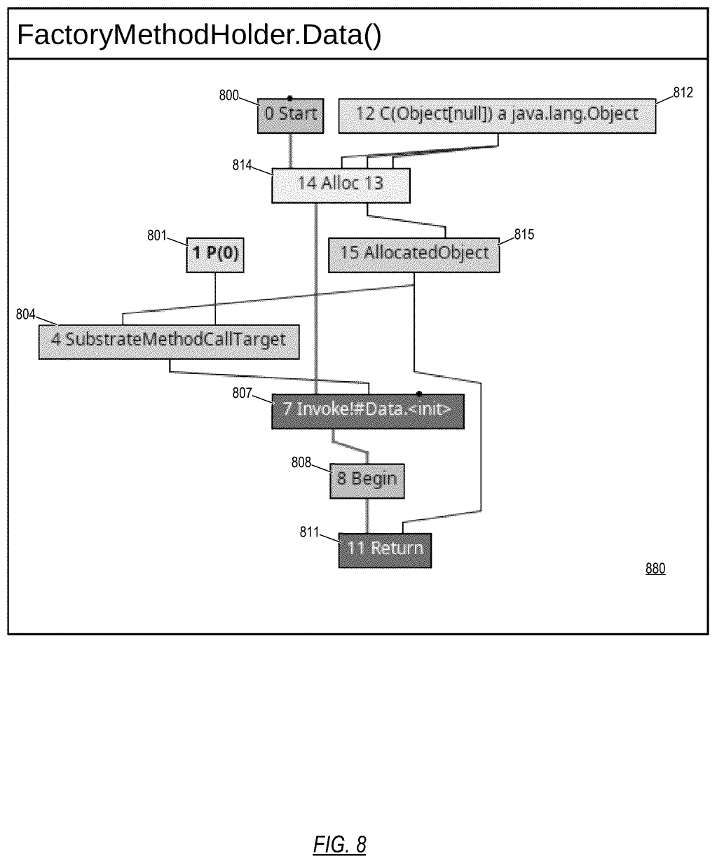

Turning to FIG. 3, the source code (300) may be displayed on a user interface and analyzed by a system in accordance with the disclosure. The text of the source code (300) is written in a programming language, e.g., Java. The source code (300) includes the sections (302), (305), (308), and (310).

The section (302) defines a class “Data”. The class “Data” includes three fields identified as “f1”, “f2”, and “f3”, which may also be referred to as “Data.f1”, “Data.f2”, and “Data.f3”.

The section (305) is a constructor for the class “Data”. The constructor executes when variables of the class are created within a program. The section (305) includes a call to the method named “escape”. The fields “f1” and “f2” are initialized before the call to the “escape” method and the field “f3” is initialized after the call to the “escape”method.

The section (308) defines the method named “escape”. The method named “escape” performs initialization checks (i.e., null checks) on the fields “f1”, “f2”, and “f3”of the class (“Data”).

The section (310) defines a method named “createData”. The method named “createData”uses objects of the “Data”class for the variables “d1”and “d2”.

With the disclosed approach, a points-to analysis of the source code (300) may prove that the fields “Data.f1” and “Data.f2” are never null at locations where the field is read. The field “Data.f3” cannot be proven to be never null. There is a load of the field “f3” in the method “escape” (in section (308)) where the field load (of “f3”) returns null.

The allocations of the class Data in the source code (300) may include the two allocations in the section (310). The text of the constructor in section (305) includes the constructor parameter “Object f”, which may be either a String instance, or a Data instance, but is not null. Without implementing the disclosure, a static analysis of the source code (300) may not prove that the fields “Data.f1” and “Data.f2” are never null, because before the field stores in the constructor, implicit stores of null are seen when the Data instances are allocated.

The fields “f1”, “f2”, and “f3” are not declared final, which may be done with the Java programming language. The disclosed approach does not rely on fields being declared final and does not benefit from that information. Declaring a field “final” indicates that the field may not be stored again outside of the constructor. Declaring a field “final” does not disallow field loads before the initializing store (i.e., the initialization of the field) in the constructor. For example, in the method “escape” of the section (308), the field “f3” would still be null even if the field “f3” was declared final.

FIG. 4, FIG. 5, FIG. 6, FIG. 7, FIG. 8, FIG. 9, and FIG. 10 show the intermediate representations (IRs) (480), (580), (680), (780), (880), (980), and (1080) from a compiled version of the source code (300) of FIG. 3, which may be displayed on a user interface. The intermediate representations (480), (580), (680), (780), (880), (980), and (1080) are static single assignment based (SSA-based) high-level intermediate representations. The boxes are nodes of the intermediate representations and represent operations of a program, like an object allocation or a field store. For instructions that produce a value, like an object allocation, the instruction also represents the produced value. Certain edges between the nodes show the usage of values. Other edges identify the order of instructions. The nodes shown may represent a subset of the nodes identified in an intermediate representation generated from the source code (300) of FIG. 3. Constructors in Java have the standardized method name “<init>”.

Turning to FIG. 4, the intermediate representation (480) for the method “Data.createData()” is generated from parsing the section (310) of the source code (300) of FIG. 3. The nodes (400), (402), (403), (404), (408), (409), (411), (412), (419), (420), and (422) each represent operations that may be performed during execution of a program compiled from the source code (300) of FIG. 3. The path including the nodes (400), (402), (408), (409), (411), (419), (420), and (422) is to be executed in the order shown in the intermediate representation (480).

In the intermediate representation (480) for the method “Data.createData()”, each of the two allocations result in two nodes (i.e., the nodes (402) and (408) and the nodes (411) and (419)) for a total of four nodes. The “New Data” nodes (402) and (411) allocate a new uninitialized object. The allocation is followed by the invocation of the constructor “Invoke!#Data.<init>”at the nodes (408) and (419).

Turning to FIG. 5, the intermediate representation (580) for the method “Data.<init>()” is generated from parsing the section (305) of the source code (300) of FIG. 3. The nodes (500), (501), (502), (504), (506), (507), (511), (512), (514), (516), (523), (524), (526), and (528) each represent operations that may be performed during execution of a program compiled from the source code (300) of FIG. 3. The path including the nodes (500), (504), (506), (511), (512), (514), (523), (524), (526), and (528) is to be executed in the order shown in the intermediate representation (580).

The constructor “Data.<init>” stores the three fields “f1”, “f2”, and “f3” at the nodes (504), (514), and (526), respectively. The newly allocated object is passed in as the method parameter P(0) at the node (501). The value stored into fields “f1” and “f3” at the nodes (504) and (526) is the method parameter P(1) of the node (502). The value stored into the field “f2” at the node (514) is a new ArrayList object. The allocation of the ArrayList object results in nodes, the “New ArrayList”node (506) and the “Invoke!#ArrayList.<init>”node (511).

FIG. 6, FIG. 7, and FIG. 8 respectively illustrate the intermediate representations (680), (780), and (880). The intermediate representations (680), (780), and (880) are generated as part of the process of outlining the intermediate representations (480) and (580) of FIG. 4 and FIG. 5.

Turning to FIG. 6, the intermediate representation (680) for the method “Data.createData()” is an updated version of the intermediate representation (480) of FIG. 4 after outlining. The nodes (600), (603), (608), (609), (619), (620), (622), (634), and (635) each represent operations that may be performed during execution of a program compiled from the source code (300) of FIG. 3. The path including the nodes (600), (608), (609), (619), (620), and (622) is to be executed in the order shown in the intermediate representation (680).

To generate the intermediate representation (680), the nodes (402) and (408) of FIG. 4 are replaced with the node (608), the nodes (411) and (419) of FIG. 4 are replaced with the node (619), and the nodes (404) and (412) of FIG. 4 are revised to the nodes (634) and (635).

The nodes (608) and (619) are a call to a synthetic method named “FactoryMethodHolder.Data”. An additional hash code may be included as a suffix for unique identification.

Turning to FIG. 7, the intermediate representation (780) for the constructor method “Data.<init>()” is an updated version of the intermediate representation (580) of FIG. 5 after outlining. The nodes (700), (701), (702), (704), (711), (714), (716), (723), (724), (726), (728), and (737) each represent operations that may be performed during execution of a program compiled from the source code (300) of FIG. 3. The path including the nodes (700), (704), and (711) as well as the path including the nodes (714), (723), (724), (726), and (728) are to be executed in the order shown in the intermediate representation (780).

To generate the intermediate representation (780), the nodes (506) and (511) of FIG. 5 are replaced with the node (711), the nodes (511) and (519) of FIG. 5 are replaced with the node (719), and the node (507) of FIG. 5 is revised to the node (737).

The node (711) is a call to a synthetic method named “FactoryMethodHolder.ArrayList”. An additional hash code may be included as a suffix for unique identification.

Turning to FIG. 8, the intermediate representation (880) is for the synthetic method “FactoryMethodHolder.Data()”. The synthetic method is generated as a part of the process of outlining and encapsulates the allocation and invocation of the class “Data” defined in the section (302) of the source code (300). The allocation of the Data object (the Alloc node (814)) has explicit field values: since an empty object is allocated, each of the three fields get the value null assigned. The nodes (800), (801), (804), (807), (808), (811), (812), (814), and (815) each represent operations that may be performed during execution of a program compiled from the source code (300) of FIG. 3. The path including the nodes (800), (814), (807), (808), and (811) is to be executed in the order shown in the intermediate representation (880).

Turning to FIG. 9, the intermediate representation (980) is for the synthetic method “FactoryMethodHolder.Data()”, which is updated from the intermediate representation (880) of FIG. 8 after a process of inlining. The nodes (900), (901), (903), (905), (907), (908), (911), (912), (914), (919), (921), (922), (924), (929), and (941) each represent operations that may be performed during execution of a program compiled from the source code (300) of FIG. 3. The path including the nodes (900), (903), (908), (911), (914), (919), (921), (924), (929), and (941) is to be executed in the order shown in the intermediate representation (980).

The inlining process incorporates operations from the constructor into the synthetic method. For example, the inlining process inlines the constructor “Data.<init>()” represented by the intermediate representation (780) of FIG. 7 into the synthetic method “FactoryMethodHolder.Data()” represented by the intermediate representation (880) of FIG. 8 to generate the intermediate representation (980). The inlining process expands the path containing the nodes (807), (808), and (811) from FIG. 8 to the path containing the nodes (908), (911), (914), (919), (921), (924), (929), and (941).

The “Alloc” node (903) allocates memory and writes null into the fields “f1”, “f2”, and “f3”. The “StoreField” nodes (908), (919), and (929) initializes the fields by writing non-null values to the fields “f1”, “f2”, and “f3”. The fields “f1” and “f2” are initialized at the nodes (908) and (919) prior to the function call to the “escape” at the node (921). The field “f3” is initialized after at the node (929) after the function call to the “escape”at the node (921).

Turning to FIG. 10, intermediate representation (1080) is for the “FactoryMethodHolder.Data()”, which is updated from the intermediate representation (980) of FIG. 9 after a partial escape analysis is performed on the intermediate representation (980) of FIG. 9. The nodes (1000), (1001), (1005), (1011), (1012), (1014), (1021), (1022), (1024), (1029), (1041), (1043), and (1044) each represent operations that may be performed during execution of a program compiled from the source code (300) of FIG. 3. The path including the nodes (1000), (1011), (1014), (1043), (1021), (1024), (1029), and (1041) is to be executed in the order shown in the intermediate representation (1080).

The allocated object (field “f3”) escapes the synthetic method before the method returns at the node (1041). The escape occurs when the allocated object (field “f3”) is passed as a parameter to the method “escape” at the node (1021). The location of the node (1021) is the latest point at which the elements of objects of the class “Data” are to be materialized. The partial escape analysis reorders the nodes (and corresponding instructions) to move the materialization of the fields “f1” and “f2” closer to this point.

The “43 Alloc” materialization node (1043) is revised to allocate and initialize (i.e., store) the fields “f1” and “f2” to corresponding initialized values as one unit. The field “f3” is still allocated and receives a value of null, because the field stored at the node (1029) to initialize the field “f3” is after the point where the object escapes the method, i.e., after the node (1021). The values stored in the fields “f1”, “f2”, and “f3” are the three incoming lines of the “43 Alloc” node (1043) (in that order).

A partial escape analysis may prove that the fields “f1” and “f2” are not accessed prior to initialization and are “never null”. By outlining calls to the constructor to a synthetic method and then inlining the instructions from the constructor to the synthetic method, there is only one materialization site in the application, i.e., the synthetic method “FactoryMethodHolder.Data()”, which may be referred to as a factory method. In the factory method, the field “f1” is set (at the node (1043)) to the method parameter P(0) (from the node (1001)), and the field “f2”is set (also at the node (1043)) to another newly allocated object.

After determining that the fields “f1” and “f2” are not accessed prior to initialization (are “never null”) using the intermediate representation (1080), redundant initialization checks may be removed. The initialization checks that are removed may be implicit or explicit. Some programming languages (e.g., Java) may require implicit initialization checks on elements prior to access to the elements. Since it is determined that the fields “f1” and “f2” are not accessed prior to their initialization, the implicit initialization checks required by the program language for the fields “f1” and “f2” may be removed from the executable code to reduce the size and reduce the runtime of the executable code. As noted above, explicit initialization checks may also be removed.

Turn to FIG. 11, the reduced code (1100) is updated from the source code (300) of a FIG. 3. The reduced code (1100) includes the sections (1102), (1105), (1108), and (1110) that are similar to the sections (302), (305), (308), and (310) at the source code (300) of FIG. 3.

The section (1108) differs from the section (308) of FIG. 3 by removing the explicit null checks in the section (1112). The null checks in the section (1112) of the fields “f1” and “f2” are removed at the programming language level by being commented out by preceding the null checks on each line with the characters “//”. The null check for the field “f3” remains since the field “f3” is accessed prior to initialization.

Embodiments may be implemented on a special purpose computing system specifically designed to achieve the improved technological result. Turning to FIGS. 12A and 12B, the special purpose computing system (1200) may include one or more computer processors (1202), non-persistent storage (1204), persistent storage (1206), a communication interface (1212) (e.g., Bluetooth interface, infrared interface, network interface, optical interface, etc.), and numerous other elements and functionalities that implement the features and elements of the disclosure. The computer processor(s) (1202) may be an integrated circuit for processing instructions. The computer processor(s) may be one or more cores or micro-cores of a processor. The computer processor(s) (1202) includes one or more processors. The one or more processors may include a central processing unit (CPU), a graphics processing unit (GPU), a tensor processing unit (TPU), combinations thereof, etc.

The input device(s) (1210) may include a touchscreen, keyboard, mouse, microphone, touchpad, electronic pen, or any other type of input device. The input device(s) (1210) may receive inputs from a user that are responsive to data and messages presented by the output device(s) (1208). The inputs may include text input, audio input, video input, etc., which may be processed and transmitted by the computing system (1200) in accordance with the disclosure. The communication interface (1212) may include an integrated circuit for connecting the computing system (1200) to a network (not shown) (e.g., a local area network (LAN), a wide area network (WAN) such as the Internet, mobile network, or any other type of network), and/or to another device, such as another computing device.

Further, the output device(s) (1208) may include a display device, a printer, external storage, or any other output device. One or more of the output device(s) (1208) may be the same or different from the input device(s) (1210). The input device(s) (1210) and the output device(s) (1208) may be locally or remotely connected to the computer processor(s) (1202). Many different types of computing systems exist, and the aforementioned input device(s) (1210) and output device(s) (1208) may take other forms. The output device(s) (1208) may display data and messages that are transmitted and received by the computing system (1200). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (1200) in FIG. 12A may be connected to or be a part of a network. For example, as shown in FIG. 12B, the network (1220) may include multiple nodes (e.g., node X (1222) and node Y (1224)). Each node may correspond to a computing system, such as the computing system (1200) shown in FIG. 12A, or a group of nodes combined may correspond to the computing system (1200) shown in FIG. 12A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1200) may be located at a remote location and connected to the other elements over a network.

The nodes (e.g., node X (1222) and node Y (1224)) in the network (1220) may be configured to provide services for a client device (1226), including receiving requests and transmitting responses to the client device (1226). For example, the nodes may be part of a cloud computing system. The client device (1226) may be a computing system, such as the computing system (1200) shown in FIG. 12A. Further, the client device (1226) may include and/or perform all or a portion of one or more embodiments of the disclosure.

The computing system (1200) of FIG. 12A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
inlining source code to generate inlined code, wherein the inlined code comprises instructions to materialize an element within a scope;
consolidating the inlined code to form consolidated code by moving the instructions to materialize the element to a point where the element escapes the scope;
running a points-to analysis on the consolidated code; and
reducing the consolidated code to generate reduced code by removing an initialization check from the consolidated code.

2. The method of claim 1, further comprising:
executing the reduced code, wherein the reduced code has a reduced execution time as compared to the inlined code.

3. The method of claim 1, wherein inlining the source code further comprises:
outlining the source code to generate outlined code prior to inlining the source code, wherein inlining the source code comprises inlining the outlined code.

4. The method of claim 1, wherein inlining the source code further comprises:
outlining the source code, prior to inlining the source code, by replacing the instructions to materialize the element in the source code with a call to a synthetic method.

5. The method of claim 1, wherein inlining the source code further comprises:
inlining the instructions to materialize the element in a synthetic method to form the inlined code.

6. The method of claim 1, wherein consolidating the inlined code further comprises:
executing a partial escape analyzer to perform a partial escape analysis on the inlined code to generate the consolidated code, wherein the partial escape analysis comprises:
identifying the scope of the inlined code, and
identifying an access to the element as the point where the element escapes the scope and located prior to a return from the scope.

7. The method of claim 1, wherein consolidating the inlined code further comprises:
consolidating the instructions to materialize the element with instructions to materialize a supplemental element in the consolidated code by initializing and allocating the element and the supplemental element as one unit.

8. The method of claim 1, wherein consolidating the inlined code further comprises:
consolidating the instructions to materialize the element to a single materialization site in a synthetic method for an application comprising the scope.

9. The method of claim 1, wherein the instructions to materialize the element comprise instructions to allocate the element and instructions to initialize the element and wherein reducing the consolidated code further comprises:
determining that the element is not accessed within the scope after the instructions to allocate the element and prior to the instructions to initialize the element.

10. The method of claim 1, wherein reducing the consolidated code further comprises:
removing the initialization check after determining that the element is not accessed within the scope between instructions to allocate the element and instructions to initialize the element, wherein the instructions to materialize the element comprise the instructions to allocate the element and the instructions to initialize the element.

11. The method of claim 1, wherein the scope corresponds to a class method of a class and the element comprises an object instantiated from the class.

12. A system comprising
at least one processor; and
an application that, when executing on the at least one processor, performs operations comprising:
inlining source code to generate inlined code, wherein the inlined code comprises instructions to materialize an element within a scope,
consolidating the inlined code to form consolidated code by moving the instructions to materialize the element to a point where the element escapes the scope,
running a points-to analysis on the consolidated code, and
reducing the consolidated code to generate reduced code by removing an initialization check from the consolidated code.

13. The system of claim 11, wherein inlining the source code further comprises:
outlining the source code to generate outlined code prior to inlining the source code, wherein inlining the source code comprises inlining the outlined code.

14. The system of claim 11, wherein inlining the source code further comprises:
outlining the source code, prior to inlining the source code, by replacing the instructions to materialize the element in the source code with a call to a synthetic method.

15. The system of claim 11, wherein inlining the source code further comprises:
inlining the instructions to materialize the element in a synthetic method to form the inlined code.

16. The system of claim 11, wherein consolidating the inlined code further comprises:
executing a partial escape analyzer to perform a partial escape analysis on the inlined code to generate the consolidated code, wherein the partial escape analysis comprises:
identifying the scope of the inlined code, and
identifying an access to the element as the point where the element escapes the scope and located prior to a return from the scope.

17. The system of claim 11, wherein consolidating the inlined code further comprises:
consolidating the instructions to materialize the element with instructions to materialize a supplemental element in the consolidated code by initializing and allocating the element and the supplemental element as one unit.

18. The system of claim 11, wherein consolidating the inlined code further comprises:
consolidating the instructions to materialize the element to a single materialization site in a synthetic method for an application comprising the scope.

19. The system of claim 11, wherein the instructions to materialize the element comprise instructions to allocate the element and instructions to initialize the element and wherein reducing the consolidated code further comprises:
determining that the element is not accessed within the scope after the instructions to allocate the element and prior to the instructions to initialize the element.

20. A non-transitory computer readable medium comprising instructions executable by at least one processor to perform:
inlining source code to generate inlined code, wherein the inlined code comprises instructions to materialize an element within a scope;
consolidating the inlined code to form consolidated code by moving the instructions to materialize the element to a point where the element escapes the scope;
running a points-to analysis on the consolidated code; and
reducing the consolidated code to generate reduced code by removing an initialization check from the consolidated code.
